(19) United States
(12) Patent Application Publication
(10) Pub. No.: US 2021/0177033 A1
(43) Pub. Date: Jun. 17, 2021

(54) ENDOSKELETAL METHOD FOR CORING, SLICING, AND PROPORTIONING SOFT-CORED OR PITTED FRUITS

(71) Applicant: Scott Berglin, Seattle, WA (US)

(72) Inventor: Scott Berglin, Seattle, WA (US)

(21) Appl. No.: 17/048,601

(22) PCT Filed: Apr. 23, 2019
(86) PCT No.: PCT/US2019/028754

§ 371 Date: Oct. 18, 2020

Related U.S. Application Data
(60) Provisional application No. 62/661,389, filed on Apr. 23, 2018.

(51) Int. Cl. A23N 4/24; B26D 3/26; A23N 4/14; A23L 19/00

(52) U.S. Cl. CPC A23N 4/24; B26D 3/26; A23V 2002/00; A23L 19/05; A23N 4/14

(57) ABSTRACT

A device and method for proportioning slices of fruit by slicing a piece of fruit into a number of slices using a endoskeletal slicing and coring device with twin-opposed coaxial upper and lower guide pins to positioning and holding the fruit, a coring tube for separating the fruit from the core, and a cassette for slicing the fruit and a proportioning device for separating the slices into a number of groups.

### PRIORITY CLAIM

This application claims priority from and the benefit of U.S. Provisional Application No. 62/661,389 filed on Apr. 23, 2018, the contents of which are hereby incorporated by reference as if fully set forth herein.

### COPYRIGHT NOTICE

This disclosure is protected under United States and/or International Copyright Laws.© 2018, 2019 Scott Berglin. All Rights Reserved. A portion of the disclosure of this patent document contains material which is subject to copyright protection. The copyright owner has no objection to the facsimile reproduction by anyone of the patent document or the patent disclosure, as it appears in the Patent and/or Trademark Office patent file or records, but otherwise reserves all copyrights whatsoever.

### CROSS REFERENCE TO RELATED PATENTS

This application relates to and improves upon my previous inventions described in: U.S. Pat. No. 7,185,583—“MACHINE FOR PRECISION LOW STRESS CORING AND SLICING OF APPLES AND OTHER SOFT-CORED OR PITTED FRUITS” issued on Mar. 6, 2007, and, U.S. Pat. No. 7,597,920—“METHOD FOR PRECISION LOW STRESS CORING AND SLICING OF APPLES AND OTHER SOFT-CORED OR PITTED FRUITS” issued on Oct. 6, 2009, the contents of which are all hereby incorporated by reference in their entirety as if fully set forth herein.

### BACKGROUND

Machines for coring and slicing (aka: segmenting, or sectioning, or wedging) fresh fruits are well documented in the art. Traditionally, these machines push a whole fruit through a plurality of fixed cutting blades, such that the edible portions of the fruit are channeled toward auxiliary (down-stream) weighing and packaging, while the inedible portions (core, stem, seed-pod, and calyx) are discarded or reserved for other purpose. The format of the fixed blades is usually a radial pattern of equally spaced blades, the outer ends of which are supported by (and attached to) a metal ring. Of necessity, the ring must be strong enough to hold the blades in place, and large enough in diameter to pass a whole fruit through its internal diameter. The number of blades determines the number of slices per fruit.

It is fundamental to the operation of these machines that, 1) the blade-ring, 2) the fruit, 3) the coring tube, 4) the pushing “ram” or “fingers”, 5) any mechanism that places the fruit in position, and, 6) any shoot, funnel or channel that receives the slices—all must be positioned co-axially, and must operate (move) on that common centerline.

Typically, these machines use an outer-frame (exoskeletal) construction, consisting of moving platforms or anchor-plates (stages) with bushings that slide on vertical columns. Each stage performs a sequential step in the slicing process (i.e., positioning or placement, coring, slicing, and channeling). Likewise, each stage uses these peripheral (exoskeletal) center-lines of motion (i.e., vertical columns) to keep the slicing process components in line co-axially. FIG. 1 represents some typical exoskeletal designs.

There are a number of drawbacks to current designs. As a result, improvements can be made to current devices and techniques for coring and slicing (aka: segmenting, or sectioning, or wedging) fresh fruits.

### SUMMARY

The basic embodiment of the disclosure features an endoskeletal construction, thus eliminating the need for external bushings, linear rails, slicing platforms or swinging arms. In one example, an endoskeletal system consists of a stationary cylinder or spindle cartridge of sufficient diameter to enclose and contain the components that affect the locating, coring, slicing, proportioning, and channeling of fresh-sliced fruit portions. The components reside, each-inside-the-other in a telescoping fashion such that inner components are cylindrically restrained by outer components, and all components are restrained to the common centerline of the stationary cylinder. Each component is activated by one or more linear actuators or air cylinders, such that all components move in sequence, concentrically and coterminously, thus effecting the locating, coring, slicing, proportioning and channeling of the fruit portions.

Whereas the basic embodiment is configured for “coring” (typically: apples, pears, oranges, grapefruit and pineapples), various embodiments relate to “sectioning” fruits that may not or do not, require coring (typically: lemons, limes, kiwi, and some oranges and grapefruit). In such embodiments, the coring function is eliminated by deactivation, and the slicing “ram” or “fingers” push the fruit through a slicing cassette where all blades are terminated at the axis center point by a needle-like pin that pierces the fruit, forcing the whole fruit to become sectioned into portions, without regard to debris, seeds, pods, navels, etc. It should be noted that in such embodiments the deactivated coring tube continues to function as a centering component in the endoskeletal construction. Further, while the invention is described with respect for fruits, the term “fruit” is merely descriptive of one embodiment shouldn't be seen as limiting.

The described systems and techniques provide for “proportioning” the fruit thereafter, into portions created by pin-location, and eccentric coring and slicing. The purpose of proportioning is to channel selected portions (slices) into packages of equal weight. The principle of proportioning an eccentrically sliced fruit is based on the geometric analysis of, by example, any cross-section through an apple that can be represented as a circle divided into twelve (12) radially triangular sections and specifically in the case where the apex of radial slicing is eccentric to the center of the circle. There is a direct correlation between the area of any triangular shape and the weight of its corresponding apple slice. The present disclosure applies this principle to the selection and channeling of specific slices, recognizing that any two twin-opposed slices will be approximately equal in combined weight to any other two twin-opposed slices. By this method, the variation in bag-weights is minimal, justifying a commercially viable alternative to weighing each slice, and therefore very competitive with form-fill-seal packaging machines.

### BRIEF DESCRIPTION OF THE DRAWINGS

Having thus described various embodiments of the disclosure in general terms, reference will now be made to the accompanying drawings, which illustrate the embodiments of the disclosure and help to illustrate the endoskeletal construction described herein. In the drawings, identical reference numbers identify similar elements or acts. The sizes and relative positions of elements in the drawings may not be necessarily drawn to scale. For example, the shapes of various elements and angles may not be drawn to scale, and some of these elements may be arbitrarily enlarged or positioned to improve drawing legibility.

FIGS. 1A-1D illustrate typical designs of exoskeletal slicing systems found in the prior art.

FIG. 2 illustrates a schematic design of an embodiment of an endoskeletal system for locating, coring, and slicing soft-cored fruits.

FIG. 3A illustrates a schematic design of another embodiment of an endoskeletal system for locating and sectioning soft-cored fruits.

FIG. 3B illustrates a schematic design of another embodiment of an endoskeletal system for locating and slicing soft-cored fruits in a rectangular format.

FIG. 4 illustrates a geometric analysis of radial sectioning of a circle in relation to the concept of proportioning.

FIG. 5A-5D illustrate a schematic design and embodiment of a proportioning method.

FIG. 6 illustrates a preferred embodiment of a device for coring, slicing and proportioning.

FIG. 7 illustrates an exploded view of moving components and assemblies of a device for coring, slicing and proportioning.

FIGS. 8A-8D illustrate sectional views of the process steps for coring, slicing and proportioning.

FIGS. 9A-9B illustrate another embodiment of a device for coring, slicing and proportioning as a fully functioning machine.

FIG. 10 illustrates other embodiments of a device for coring, slicing and proportioning as a fully functioning machine.

FIG. 11 illustrates an example wiring diagram for an embodiment of an endoskeletal system for locating, coring, and slicing soft-cored fruits.

FIG. 12 illustrates an example “ladder logic” program for a PLC—Program Logic Controller of an embodiment of an endoskeletal system for locating, coring, and slicing soft-cored fruits.

FIGS. 13A-B illustrate a method for slicing fruit in horizontal rings before slicing into vertical segments.

FIGS. 14A-B illustrates variations in the number and size of slices in an apple from use of various embodiments of the present invention.

### DETAILED DESCRIPTION

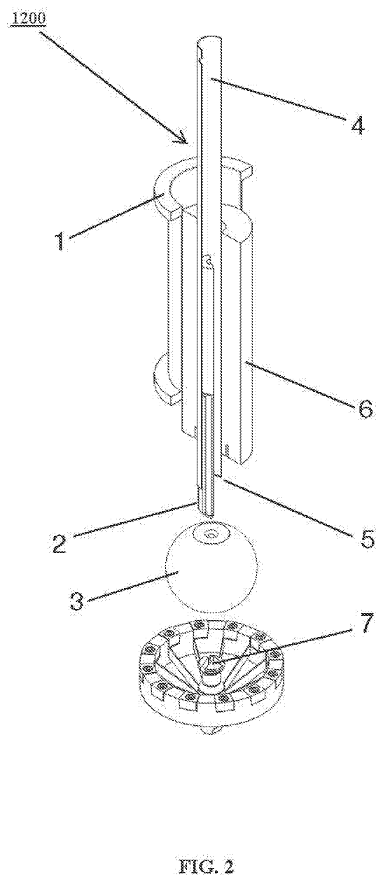

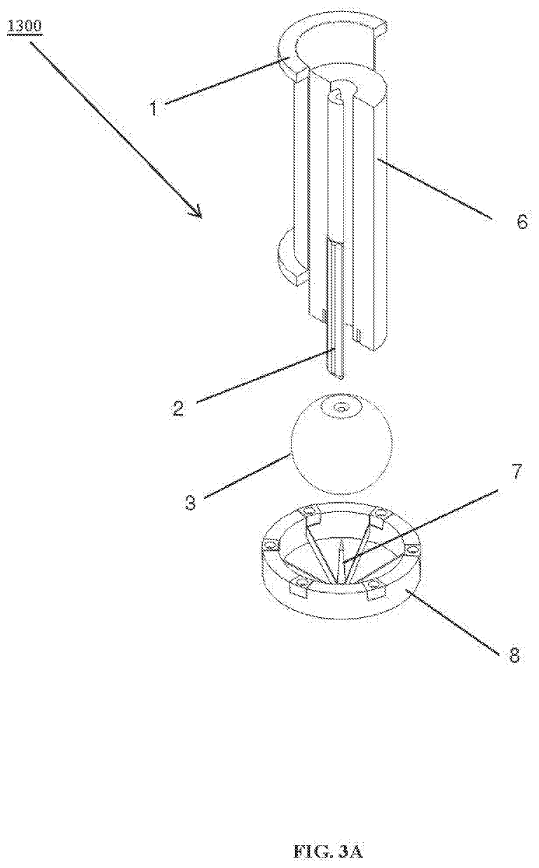

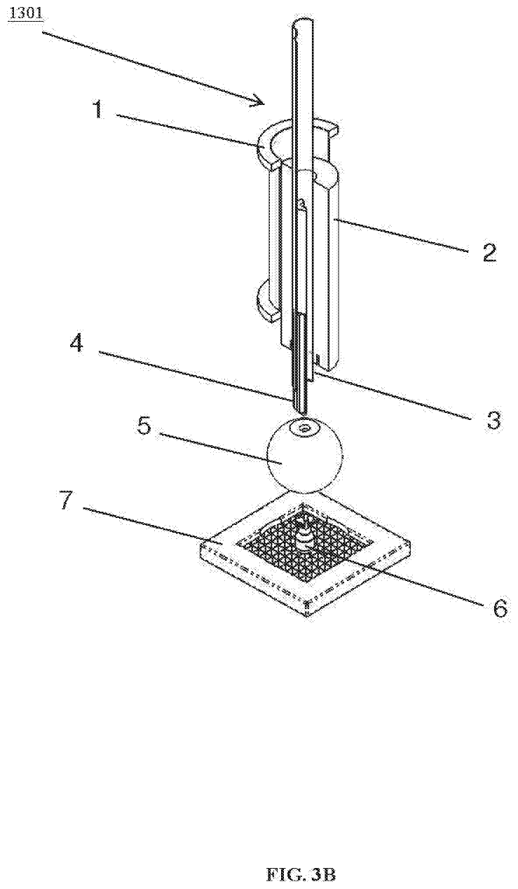

The basic embodiment of the disclosure features an endoskeletal construction, thus eliminating the need for external bushings, linear rails, slicing platforms or swinging arms. In one example, an endoskeletal system consists of a stationary cylinder or spindle cartridge of sufficient diameter to enclose and contain the components that affect the locating, coring, slicing, proportioning, and channeling of fresh-sliced fruit portions. The components reside, each-inside-the-other in a telescoping fashion such that inner components are cylindrically restrained by outer components, and all components are restrained to the common centerline of the stationary cylinder. Each component is activated by one or more linear actuators or air cylinders, such that all components move in sequence, concentrically and coterminously, thus effecting the locating, coring, slicing, proportioning and channeling of the fruit portions. FIG. 2 graphically depicts a schematic basic embodiment of the described system/device

Whereas the basic embodiment is configured for “coring” (typically: apples, pears, oranges, grapefruit and pineapples), various embodiments relate to “sectioning” fruits that may not or do not, require coring (typically: lemons, limes, kiwi, and some oranges and grapefruit). In such embodiments, the coring function is eliminated by deactivation, and the slicing “ram” or “fingers” push the fruit through a slicing cassette where all blades are terminated at the axis center point by a needle-like pin that pierces the fruit, forcing the whole fruit to become sectioned into portions, without regard to debris, seeds, pods, navels, etc. It should be noted that in such embodiments the deactivated coring tube continues to function as a centering component in the endoskeletal construction. FIG. 3 graphically depicts a typical embodiment configured for sectioning fruits (coring tube hidden for clarity).

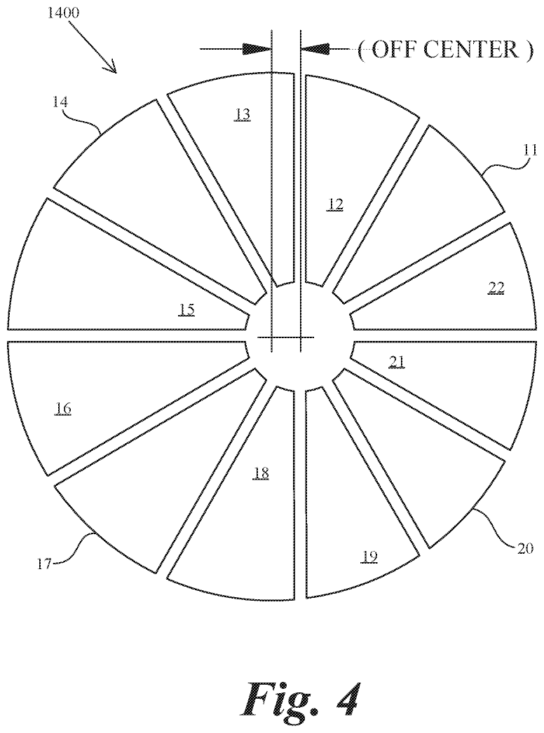

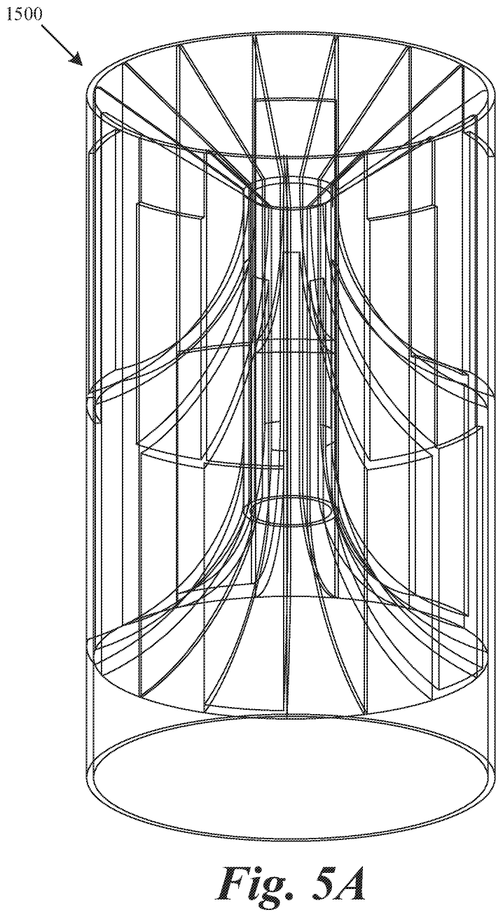

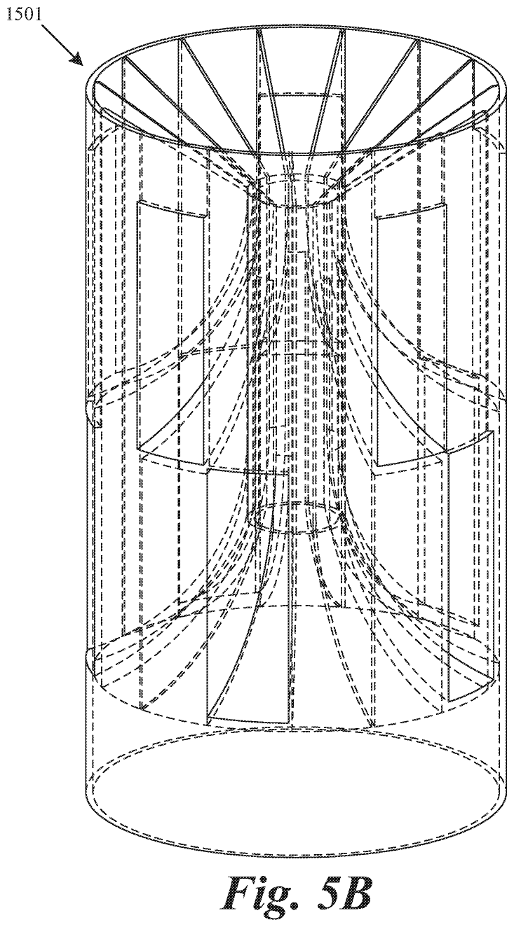

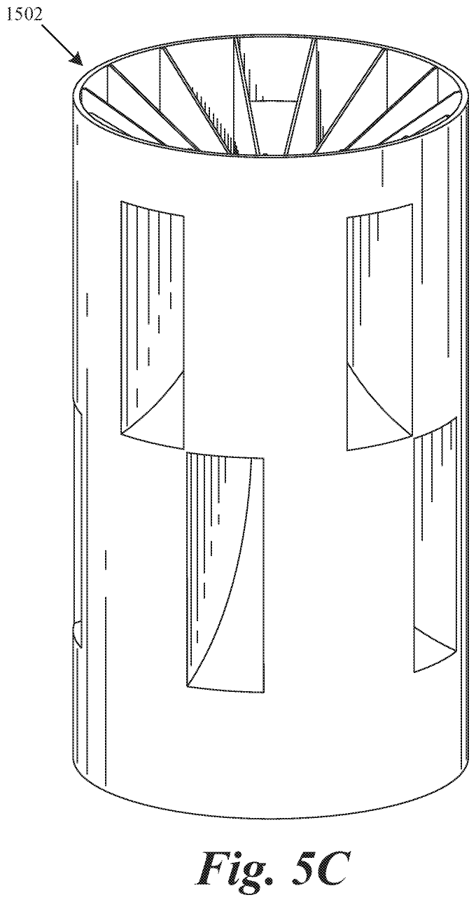

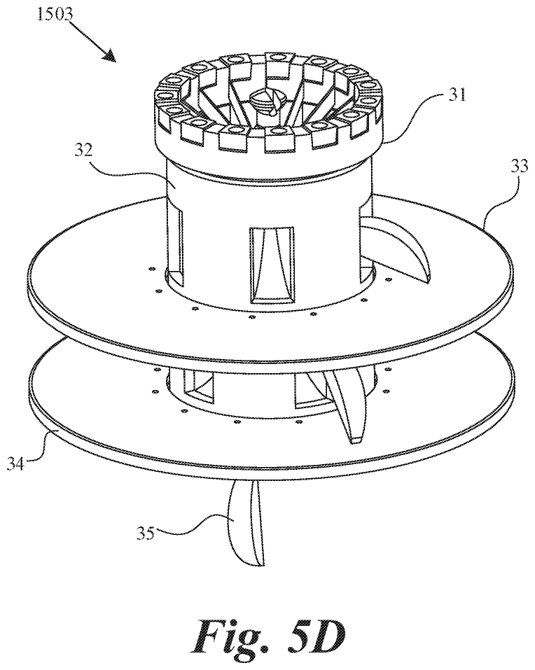

Various embodiments benefit from current art described in U.S. Pat. Nos. 7,185,583 and 7,597,920, and specifically to the use of pins located in the stem hole and calyx of a fruit to align the core of the fruit with the center axis of slicing. This method of locating a fruit acknowledges that the core of the fruit is not always in the geometric center of the fruit, but the core is always in line with the stem hole and calyx. In the aforementioned patents, the purpose of pin-location is to find, isolate and remove the whole core of the fruit. The current disclosure provides for “proportioning” the fruit thereafter, into portions created by pin-location, and eccentric coring and slicing. The purpose of proportioning is to channel selected portions (slices) into packages of equal weight. The principle of proportioning an eccentrically sliced fruit is based on the geometric analysis of, by example, any cross-section through an apple that can be represented as a circle divided into twelve radially triangular sections and specifically in the case where the apex of radial slicing is eccentric to the center of the circle. There is a direct correlation between the area of any triangular shape and the weight of its corresponding apple slice. The present disclosure applies this principle to the selection and channeling of specific slices, recognizing that any two twin-opposed slices will be approximately equal in combined weight to any other two twin-opposed slices. Thus, in this example, when every 3rd slice (radially) in the mix of twelve eccentrically shaped slices are channeled into 3 bags of 4 slices each, a 6 oz net apple weight will be reduced to 3 bags of 2 oz. each. Likewise, a fifteen slice pattern could be logically proportioned into 3 bags of 5 slices each at a weight of 2 oz per bag. By this method, the variation in bag-weights is minimal, justifying a commercially viable alternative to weighing each slice, and therefore very competitive with form-fill-seal packaging machines. FIG. 4 depicts the geometric principle behind slicing fruit eccentrically while maintaining multiple portions of equal weight. FIG. 5 depicts a Proportioning Device that applies the principle to channeling 15 slices into 3 equal-weight combined portions of 5 slices each.

Through, in part, identification of specific problems with past designs, the presently described systems and techniques were developed. There are four major drawbacks to existing exoskeletal designs—1) the number of components required to produce them, 2) the accuracy required to manufacture and assemble sliding stages of components that won't bind up or seize due to eccentricities, wear, residue build-up or lack of lubrication, and, 4) the slower operating speeds of such systems, due to their threshold of mechanical friction that must be overcome, and the “work” (energy×force) required to reverse the direction of mass (heavy-weighted components) on a continuous and cyclical basis. It is typical in such machinery that an 8 oz apple is sliced by 100 lbs of stainless-steel mechanism operating in a 1 to 2 second cycle of reciprocating motion. Each of these drawbacks is associated with extra cost, or with unnecessary or redundant maintenance and repair, or higher energy usage. These extra costs are significantly reduced or eliminated by an endoskeletal construction method as presented herewith.

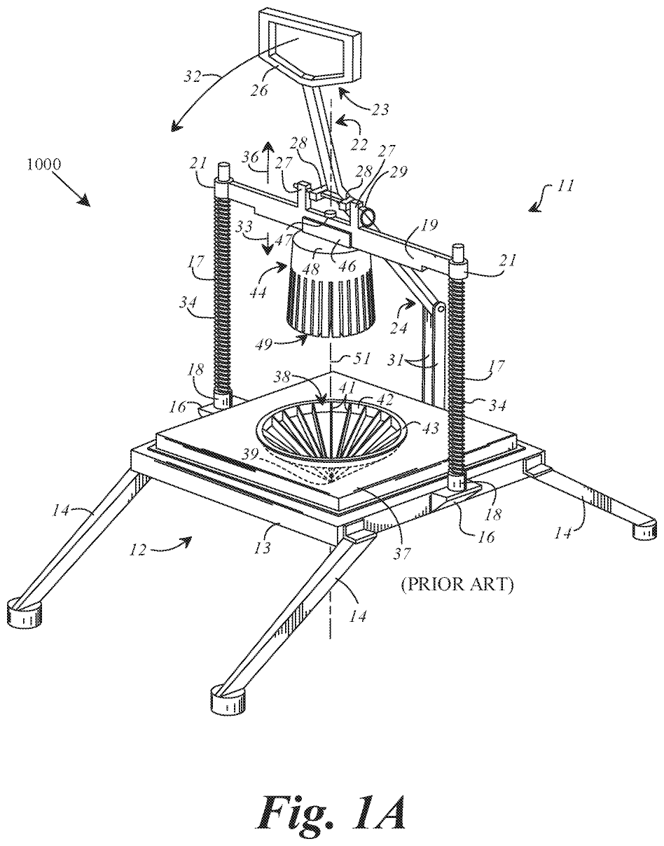

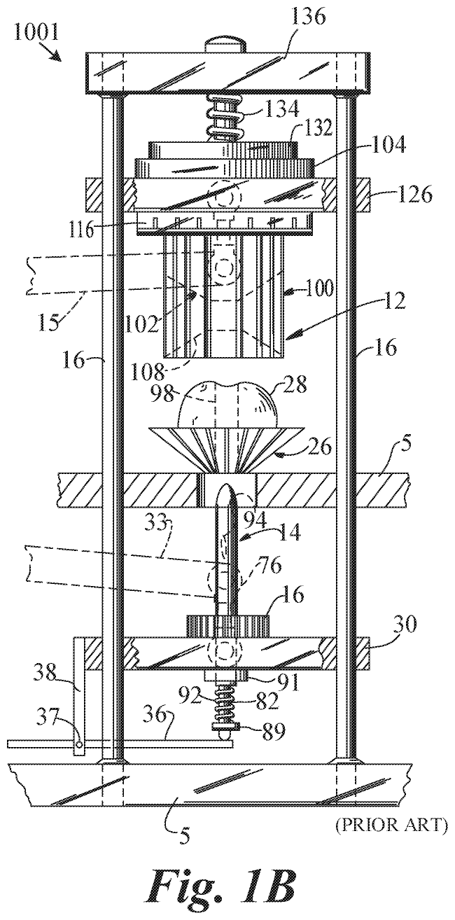

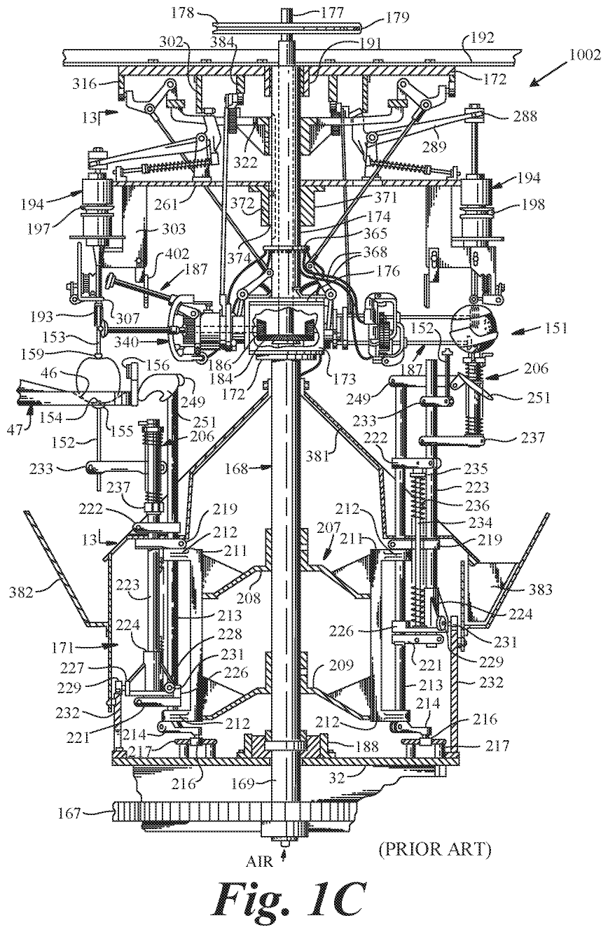

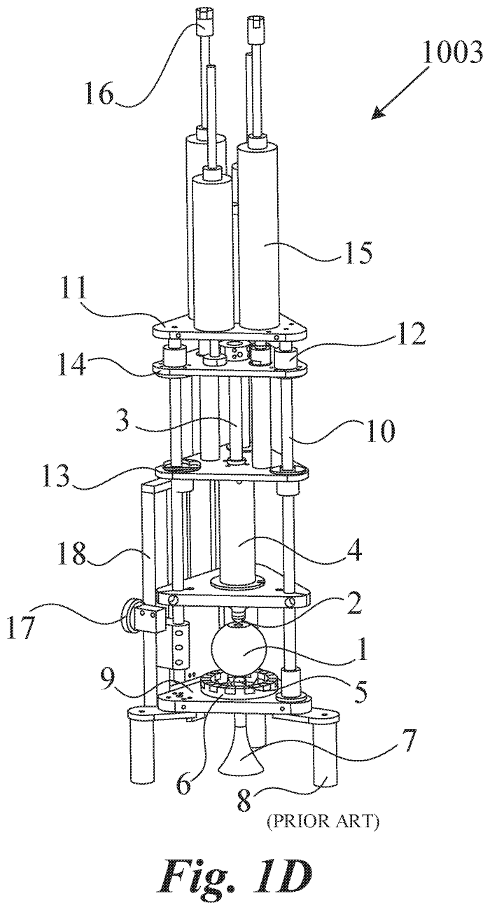

FIGS. 1A-1D each illustrate embodiments 1000, 1001, 1002, and 1003, all known in the prior art of exoskeletal constructions for machines that core and/or slice fruits.

In FIG. 1A, prior art embodiment 1000 is depicted where two springs (34) support a moving lintel (21) that slides on columns (17). These combined components comprise an exoskeletal frame that holds a ram (49) concentric with a slicing cassette (38) while fruit is sliced by a force applied to a handle (26) directed through an arc (32).

In FIG. 1B, prior art embodiment 1001 is depicted where three platforms (136), (5), and (30) slide on two columns (16), supported by a lintel (136) to locate and slice a whole fruit. These components comprise an exoskeletal frame that holds the fruit (28), an orienting pin (14), a ram (100), and a slicing cassette (26), each in a coaxial position during slicing.

In FIG. 1C, prior art embodiment 1002 is depicted where platforms (261 and 322) swivel and/or slide on a center columns (168 and 174), through several index positions, using bushings (194) to orient fruits sequentially and successively in coaxial locations with, orienting pins (152 and 153), piercing forks (193), coring tubes (206), peeling arms (187). As well, subsystems of levers (226), sliding on vertical columns (213), actuate to orient fruits in line with index positions. All of this framing comprises an exoskeletal construction.

In FIG. 1D, prior art embodiment 1003 is depicted where two platforms (14 and 13) using bushings (12) in line with vertical columns (10) supported by a common top plate (11), together comprise an exoskeletal system for holding the fruit (1), the locating pins (2 and 5), the coring tube (3), the ram (4), and the blade cassette (6), all on a common centerline.

In all cases of FIGS. 1A, 1B, 1Cc, 1Dd, it should be recognized that external structural members hold critical process components in a central or “internal” location, hence the distinction between “exoskeletal” and “endoskeletal” construction.

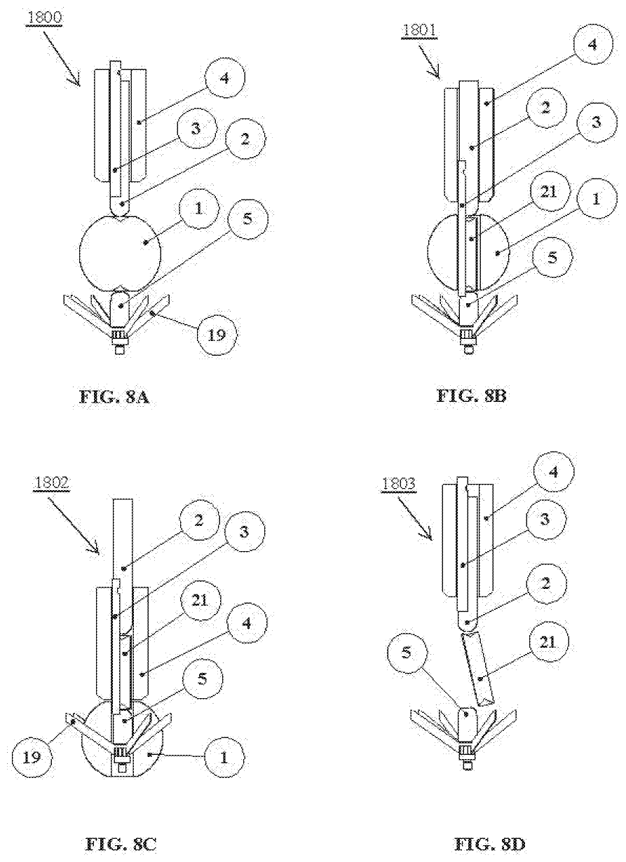

FIG. 2 illustrates a schematic design of a device 1200 including elements of an endoskeletal system for locating, coring, and slicing soft-cored fruits. A stationary cylinder or spindle cartridge (1) in a fixed location in a fruit-slicing machine provides the coaxial position, restraint and bearing (sliding fit) for all other elements. A round ram (6) fits inside the cylinder (1) with adequate clearance to allow for a light lubrication between the inside surface of the cylinder (1) and outside surface of the ram (6), if necessary. A coring tube (4) fits inside the ram, likewise with adequate clearance for lubrication between parts, if necessary. And a top-locating pin (2) fits inside the coring tube (4), likewise with adequate clearance for lubrication between parts, if necessary. For the purpose of locating, coring and slicing fruit, each of the aforementioned components may be manufactured from food-grade materials which have a natural lubricity between them. For example, the stationary cylinder or spindle cartridge (1) may be stainless steel, the ram (6) may be acetyl, the coring tube (4) may be stainless steel, and the top-locating pin may be acetyl—such that all components slide easily between them with little or no friction. In the production sequence, a fruit is initially located by hand between the top-locating pin (2) and the lower-locating pin (7). Thereafter, the core tube (4) pierces the fruit (3) to isolate and separate the core. Thereafter, the ram (6) descends to put the edible portion of the fruit through the cutting blades in the cassette. A full description of this process is illustrated in FIG. 8. In some aspects, one or more of the above-described components may be lubricated with water and/or chlorinated water. The water may be delivered to the interfaces between one or more of these components via water or Zerk or other similar fittings, for example. In yet some designs, roller bearings, ball bearings, or other active lubricating components may be utilized to lubricate the contact between one or more of the above-described components.

FIG. 3A illustrates a schematic design of a device 1300 including elements of an endoskeletal system for locating, coring, and sectioning soft-cored fruits. As in FIG. 2, a stationary cylinder or spindle cartridge (1) in a fixed location in a fruit-slicing machine provides the coaxial position, restraint and bearing (sliding fit) for all other elements. Likewise, all other sliding components described in FIG. 2 perform in the same way, except that the core tube (not shown) is either eliminated or deactivated, and a slicing cassette (8) is fitted with a needle-pin (9). In this embodiment, the top-locating pin (2) holds the fruit (3) on the coaxial line of movement over the needle-pin, and the ram (6) pushes the fruit through the slicing blades, without removing the stem, calyx, seeds, pod or navel of the fruit. Theoretically, the whole fruit is sectioned and channeled toward packaging.

FIG. 3B illustrates a schematic design of a device 1301 including elements of an endoskeletal system for locating, coring, and slicing soft cored fruits. As in FIG. 2, a stationary cylinder or spindle cartridge (1) in a fixed location in a fruit-slicing machine provides the coaxial position, restraint and bearing (sliding fit) for a ram (2), a core tube (3), and an upper locating pin (4). Likewise, all other sliding components described in FIG. 2, and herein perform n the same way.

However, a cassette with a rectangular matrix of blades (7) replaces a radial set of blades, with the purpose of coterminously slicing square or rectangular sections into shapes that are similar in appearance to “French Fries”. The rectangular matrix of blades (7) is fitted with the same or similar lower pin (6) used in other embodiments. In this embodiment, the fruit is placed between upper (4) and lower (6) pins in the same way as other embodiments and processed in the same sequence as described in FIG. 8. In alternative arrangements, a rectangular matrix of blades may incorporate a lower pin on top and in the middle of the cassette. This allows the machine to core the apple, spit the core out and push the edible portion of the apple through the knife matrix, thus cutting the apple into “French Fry” shapes in one single downward thrust coterminously from a whole apple.

What is novel in this embodiment is the facility to remove the core of the fruit before slicing, such that no debris, seeds, pods, stem or carpel is passed through the blade matrix, thus assuring that only net edible “fry” cuts channeled to treatment and packaging.

FIG. 4 illustrates a geometric analysis 1400 of the slices created in a fruit, if and when the fruit is cored off center. This “eccentric coring” happens when the core of the fruit is not in the geometric center of the fruit. The eccentricity is created when the fruit is located between pins as described in FIGS. 1, 2, and 8. In this analysis 1400 it is readily observed that a fruit cored off center (horizontally to the right) of its outside diameter (and likewise, off the center of its mass), results in slices (15 and 16) of greater size and weight on one (left) side of the fruit, while twin-opposed slices (21 and 22) are of lesser size and weight on the other (right) side of the fruit. However, in a direction 90° (normal) to the eccentricity, the size and weight of slices (12 and 13) remain relatively equal to their twin-opposed counterparts (18 and 19). And finally, in angular directions, such as slices (11 and 17) it can be seen that one slice (17) has a bias toward larger size and weight, and the twin-opposed slice (11) has a bias toward smaller size and weight. A mathematician would acknowledge that although the slices are of different size and weight, the biases are of an equal and opposite equivalency, leading to the purest mathematical proof, as follows:

At the extreme geometric condition of two eccentric circles; a) sliced as shown, and, b) where the number of radial slices approaches infinity; it can be proven that the combined area any two twin-opposed triangular sections will equal the combined area of any other twin-opposed triangular sections. That equivalency increases as the number of “slices” increase, and decreases as the number of slices decrease.

In the field of slicing soft cored and pitted fruits, that equivalency need only satisfy the minimum packing-weight requirements as set forth by commercial standards. Therefore, a method of proportioning and channeling selected slices based on their relative radial position, is fundamental to various embodiments, and this principle applies equally well to fruits with concentric cores, or eccentric cores.

Therefore, in the example of FIG. 4 for any given fruit size, slices 11, 14, 17, and 20 would be segregated (proportioned) and channeled to a single bag. Likewise, slices 12, 15, 18, and 21 would be channeled to another single bag. And slices 13, 16, 19, and 22 would be channeled into a third single bag. Thus, all of the bags would approximate the same weight for commercial purposes.

Embodiments of this principle function work equally well with even or odd numbers of slices.

FIG. 5A-C illustrates a schematic design and embodiment of a proportioning system and method in various phases of transparency through 1500, 1501, and 1502. Three upper views of the same Proportioner (32) appear as transparent 1500, translucent 1501, and opaque 1502, the purpose being to clarify that vertical, triangular “flutes” channel selected fruit portions into three “exit zones” or levels.

FIG. 5D illustrates a subcomponent 1503 according to an embodiment of the invention. The proportioning begins when a fruit has been cored and sliced into 15 slices, for example, by the blade slicing cassette (31). The Proportioner (32) is concentric with the blade cassette (31), and positioned radially so that the flutes in the Proportioner (31) are aligned exactly with the gaps between blades in the slicing cassette (32), allowing fruit slices (35) to fall directly without impediment, each in their own flute, until they slide out exit-windows. Both Proportioner and slicing cassette are fixed in position and coaxial with each other and with the locating, coring and slicing components above them. In the embodiment shown, three separate combinations of every-5th-slice are proportioned and channeled through exit windows. The first combination of 5 each slices exit onto the top swivel-plate (33) which spins, allowing a wiping blade (not shown) or other method to channel the slices into a single package. The second combination of 5 each slices exit through a lower level of exit-windows, onto the lower swivel-plate (34), where they are similarly channeled into a 2nd single package. The third and final combination of 5 each slices (35) fall directly downward into a 3rd single package.

In some aspects, it is important to the design of the Proportioner that the whole core of the fruit (including stem, seeds, pod and calyx) be removed by coring before the fruit is sliced and proportioned, thus assuring that the net packaged weight of all slices is edible. This requires upper and lower pin-location of the fruit.

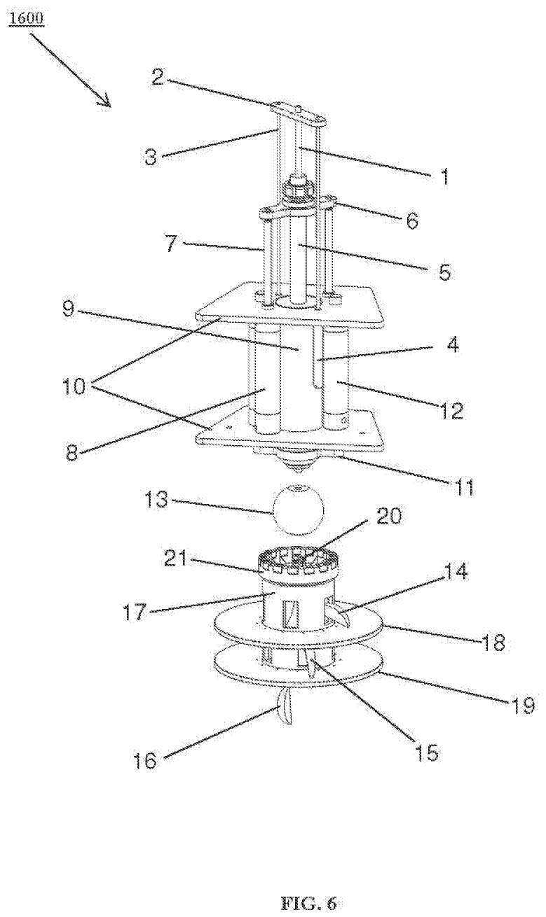

FIG. 6 illustrates a more detailed view of a preferred embodiment 1600 of the device/system for coring, slicing and proportioning which will now be structurally described.

A stationary cylinder or spindle cartridge (9) and positioned in a fixed location between two plates (10). Twin opposed air cylinders (12) driving the ram's lintel (11) are fixed in position between the plates (10). Also, twin opposed air cylinders (8) driving the coring tube's cylinder rods (7), and lintel (6) are fixed in position between the plates (10). The cylinders (12 and 8) serve two functions; a) to actuate the core tube and ram as needed, and, b) to locate and restrain the stationary cylinder (or spindle cartridge) (9), to the plates (10)—in effect acting as tension bolts.

Two additional cylinders (4) drive the top-locating pin (1) by way of attachment to the top-locating pin's lintel (2) and cylinder rods (3). These cylinders (4) are fixed in position to the upper plate (10) as shown, and they in turn are actuated as needed.

When a fruit (13) is placed by hand or other means, in the proximal area between top-locating pin (1) and bottom-locating pin (20) residing in axial center of slicing cassette (21), the top-locating pin (1) is activated and descends to capture the fruit between the aforementioned pins located in the stem hole and the calyx of the fruit respectively.

When the coring tube (5) is activated, it slides over the top-locating pin telescopically, thus fully piercing the fruit and isolating the core.

When the ram (11) is activated, it slides over the coring tube (5) and pushes the already cored fruit over the bottom pin (20), through the slicing blades in the cassette (21), so that slices (14, 15, 16) are channeled through their respective flutes of the Proportioner (17) and thereafter exit through windows onto swiveling plates (18, 19) or straight through the Proportioner, such that 3 exit zones accumulate equal-combined-weights of multiple fruit portions or slices.

It should be recognized that in most cases of actuation of the air cylinder rods attached to lintels (2, 6, 11), the lintels and the cylinder rods do not provide lateral restraint of, or concentric positioning to the aforementioned pins, core tube, and ram. They only provide linear, coaxial motion. Lateral restraint, concentricity and free bearing (sliding fit) are all provided by the static cylinder or spindle cartridge (9). This principle is novel to, and helps to define, at least some aspects of the endoskeletal method of the present disclosure.

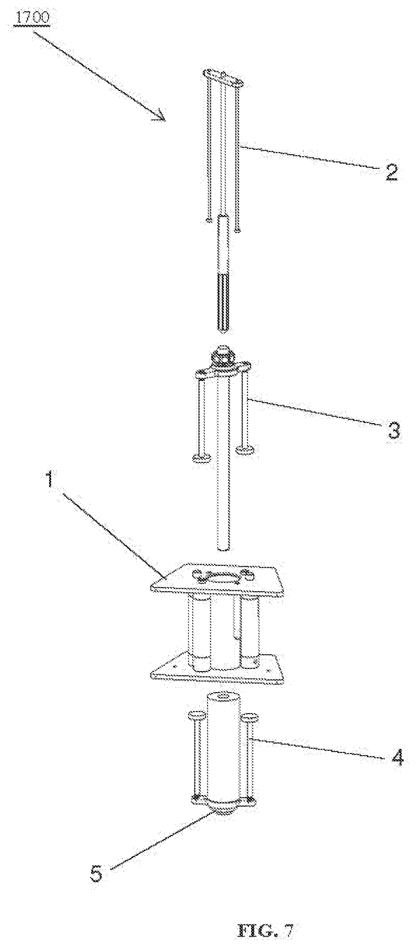

FIG. 7 illustrates, in exploded-view-form, the separate stages of a preferred embodiment 1700 of the endoskeletal method of locating, coring and slicing.

A fixed-in-position “spindle cartridge housing assembly” (1), consisting of the static cylinder or spindle cartridge, plates, and cylinders described in reference to FIG. 6 is oriented in a vertical direction, generally in the middle of the fruit coring and slicing machine.

A top-locating pin assembly or stage (2) consists of air cylinder rods attached to a lintel (above), which is attached to the top-locating pin, such that the top-locating pin slides easily but snuggly through the core tube without binding.

A core-tube assembly or stage (3) consists of air cylinder rods attached to a lintel (above), which is attached to the coring tube, such that the coring tube slides easily but snuggly through the ram without binding.

A ram assembly or stage (4) consists of air cylinder rods attached to a lintel (below), which is attached to the ram, such that the ram slides easily but snuggly through the static cylinder of the “spindle carriage housing assembly” (1).

It should be noted that a soft rubber, urethane or silicone “nose” (5) on the lower end of the ram assembly (4) engages the already-cored fruit and pushes the fruit through the slicing blades without damaging the meat or skin of the fruit.

FIGS. 8A-8D illustrate sectional views of the components, the process steps of pin-location, coring and slicing, 1800, 1801, 1802, and 1803; which is explained in U.S. Pat. Nos. 7,185,583, and 7,597,920. The process is described here for purposes of understanding the process without regard to the skeletal construction of the machine.

Apples (1) are positioned by human discretion and oriented by hand so that the calyx of the apple rests on a vertical lower guide pin (5). Concurrently, as part of an automated cycle, an upper guide pin (2), coaxial with the lower guide pin (5), descends into the stem hole until a preset pressure between pins secures the apple in a stationary position, held by a compressive force through its core, as shown in FIG. 8A.

The operator's hand is removed and the cycle continues such that a thin-walled coring tube (3) descends downward, piloting over the upper guide pin (2) and through the apple (1) in a piercing motion until it reaches the lower guide pin (5), thus separating the core of the apple from the rest of the apple, internally, as shown in FIG. 8B.

Thereafter, a soft rubber faced ram (4) descends downward, piloting over the core tube (3) as it pushes the apple through a cassette of radial knife blades (19) so as to create a plurality of wedges in a single descent. The apple is guided through its descent, first over the core tube (3), and secondly over the lower guide pin (5). A tapered support pillar under the knives induces the wedges to separate from each other as they descend into a solution of enzymes that immediately seal freshness into the apple by preventing oxygen from reacting with the raw cell structure of the sliced wedges, as shown in FIG. 8C.

Thereafter, the ram, core tube and upper guide pin (2, 3, & 4) retract to their upper positions allowing the solid apple core (21) to be ejected at a precise moment by air blast or other method, as shown in FIG. 8D.

At this point the operator is ready to place another apple and the cycle repeats.

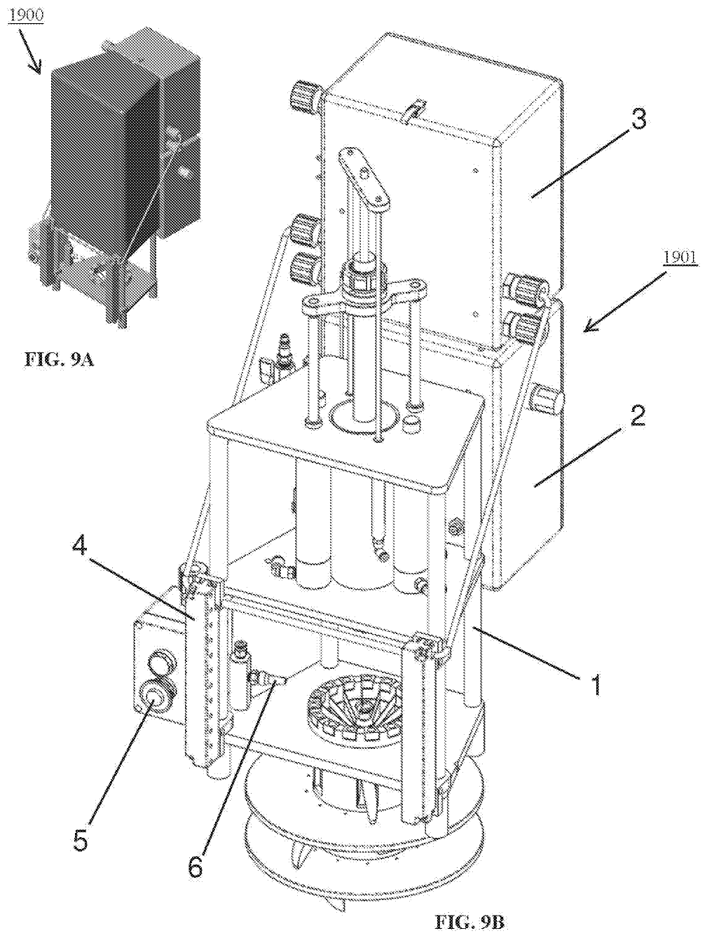

FIGS. 9A-9B illustrate another preferred embodiment 1900 and 1901 of the described device/system as a fully functional machine.

An opaque view of the machine 1900 is shown in the upper left corner of FIG. 9A, with the machine cover in place, to identify the appearance of the machine as commercially offered. The main view of FIG. 9B shows the fully functional machine 1901 with covers and safety guards removed.

Vertical columns (1) in four corners of the machine, attached to plates on three levels of the machine, providing a ridged frame to which all functional components and ancillary components can be attached and secured. It is important to note that these vertical columns do not move, nor do the plates attached to the columns move. Nor do any other components use these columns to effect motion.

A pneumatic control box (2) attaches to the rear of the machine. It houses the air valves and relay actuators which control the sequence of locating, coring and slicing fruit. An electrical control box (3) is attached above the pneumatic box and is attached to the rear of the machine. It houses the power-supply, program logic circuit (PLC), and electrical relays which define the sequence of operation of the machine. An operator's panel (5) provides buttons for powering up and shutting down the machine, and for pausing the cycle of the machine. Twin-opposed infrared sensors (4) monitor the operators access to the slicing chamber, allowing for fruits to be loaded and recognized, and to prevent objects (or human hands) from entering the machine at an unsafe moment. An air-blast nozzle (6) ejects cores after slicing and signals the end of the cycle.

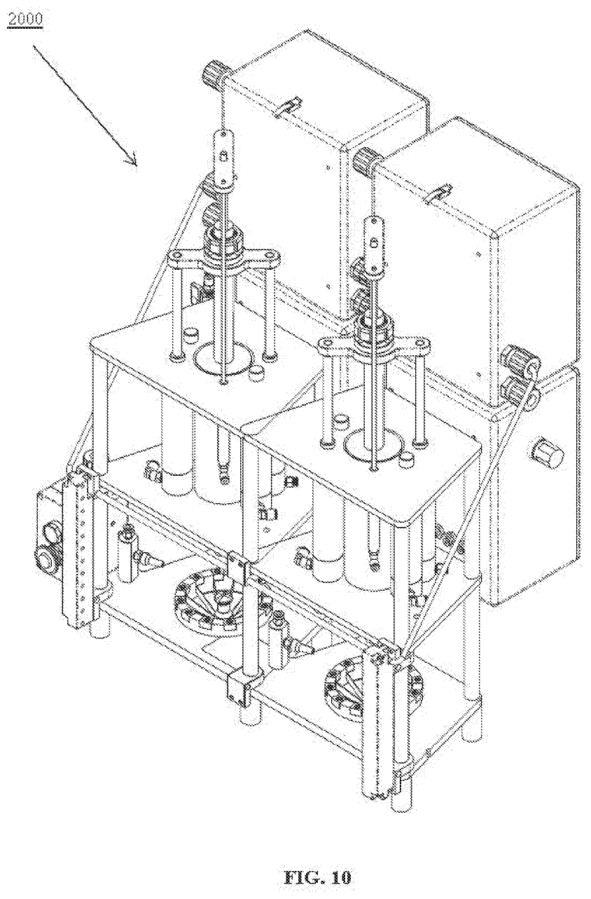

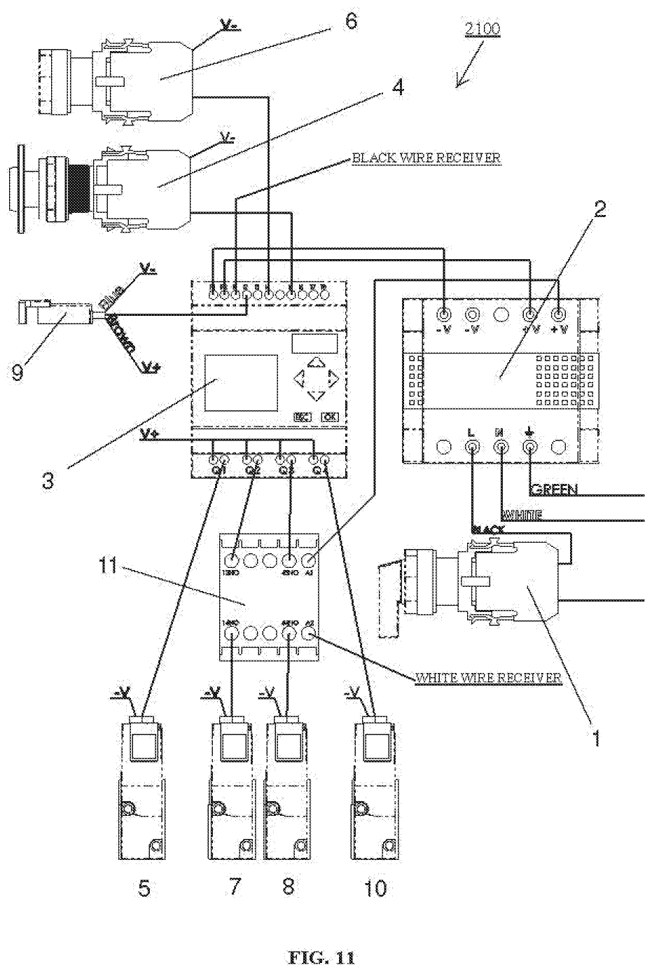

FIG. 10 illustrates an alternative preferred embodiment 2000 of described device/system. Because of the endoskeletal method of construction, and specifically the compact nature of a single cylinder or spindle cartridge providing all the benefits of location, concentricity, low friction operation and low cost of manufacture, the design lends itself to multiple spindles being incorporated into a single machine. FIG. 10 shows how a two-spindle machine can be configured, with some redundant components being eliminated.

FIG. 11 illustrates an example wiring diagram for a preferred embodiment 2100 of the described device/system operating on DC voltage. The annotations on FIG. 11 generally designate the color-code of wiring. “V+” indicates a connection to the direct current (DC) positive pole. “V−” indicates a connection to the DC negative pole.

A main power-switch (1) is turned on to activate the power-supply (2) and the PLC—Programmed Logic Controller (3). Thereafter, the operator deactivates the Emergency Stop Button (4) to make the system ready for operation. When the operator places a fruit in the machine, an IR Curtain recognizes the entry and activates the 2-way relay air valve (5) which in turn lowers the upper locating pin into the fruit. If the pin is miss-located, the operator can temporarily raise the pin by pressing the Retract Button (6). Upon releasing and removing his hand from the machine, the IR curtain acknowledges the departure of his hand and the PLC (3) initiates a signal to the 2nd relay air valve (7) through the safety-relay (11), which activates the coring tube. At a programmed interval after the core tube, the PLC (3) initiates a signal through the safety-relay (11), to the 3rd relay air valve (8) which activates the ram. When the ram reaches the desired depth of stroke (which is adjustable), a Magnetic Sensor (9) on the ram air cylinder reverses signals to the three previous air valves, thus reversing their direction. This exposes the previously captured core of the fruit, which, at this point, is ejected by an air blast initiated by the PLC (3) to the 4th relay air valve (10). At the end of the air blast, the system resets itself for the next placement of fruit, and the cycle repeats.

Power Supplies and PLC's are well known in the automation industry, and available from such companies as IDEC, Eaton, Allen Bradley, Siemens, Omron, Mitsubishi, General Electric and others. Relay Air Valves (known as flow-control valves) are available from Clippard, Bimba, Emerson, and many others.

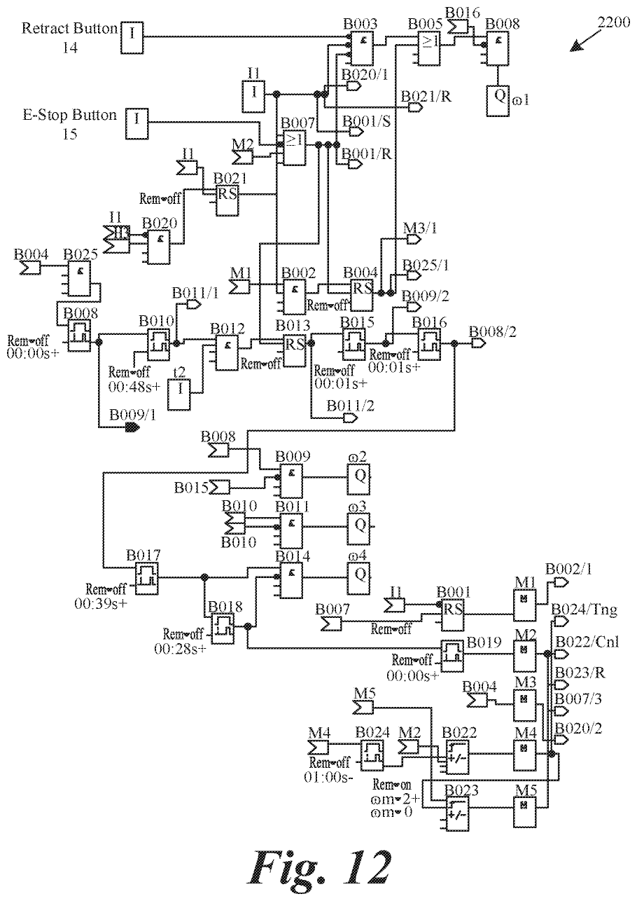

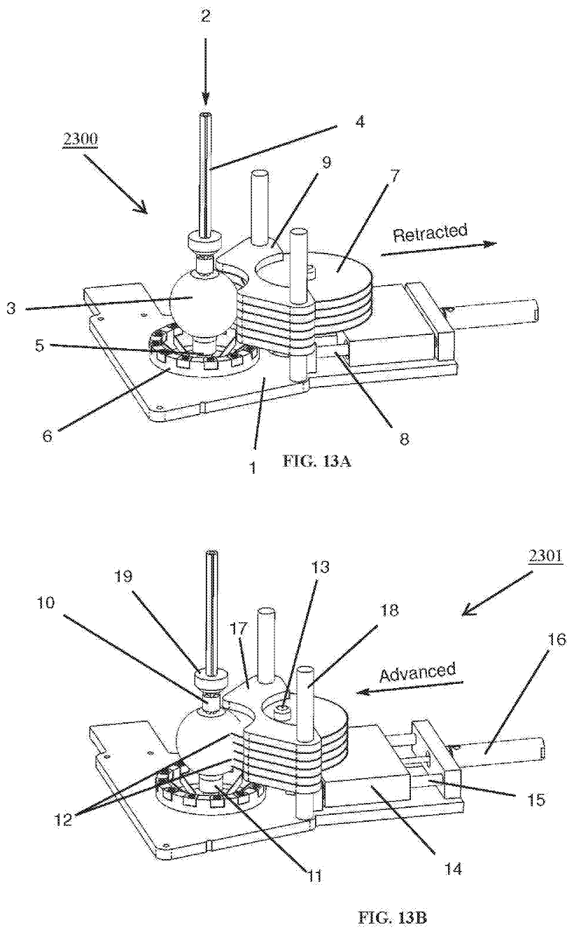

FIG. 12 illustrates a typical “ladder logic” program 2200 for a PLC—Program Logic Controller. Often these programs take the form of a “block” style tree diagram, the software of which is proprietary to the manufacturer of the PLC. The program shown is “block” format and the software is available from IDEC Corporation. Any automation engineer skilled in the art can author a program to control electro-pneumatic systems such as used in the present disclosure and will recognize the object-oriented block-format of ladder logic shown in FIG. 12.

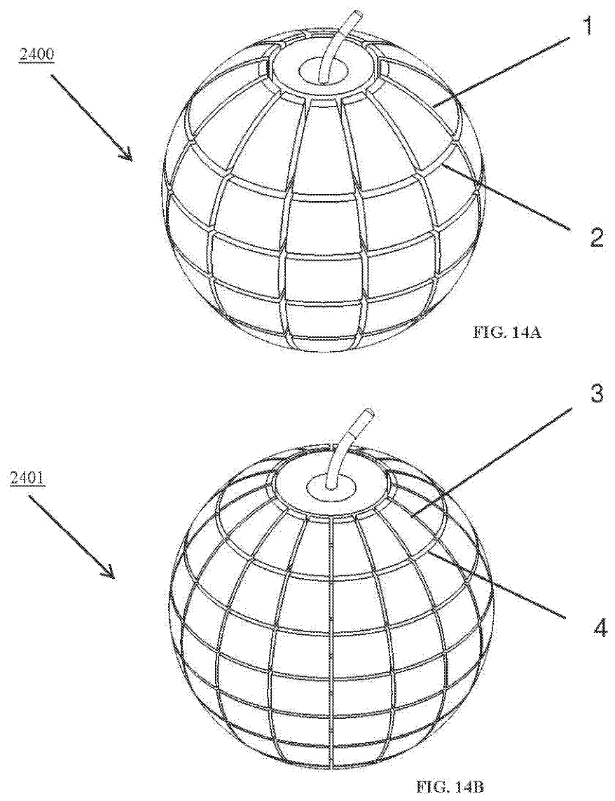

FIGS. 13A-13B illustrate a schematic design and embodiment of a “Ring Cutting” system 2300 and 2301. “Ring cutting” apples around their periphery (in advance of slicing) is a new concept for dicing apples. The depicted arrangement and devise cuts horizontal bands around the apple while it is in position for slicing. This arrangement can be incorporated into the endoskeletal device for locating, coring and slicing fruits in shorter-length segments (diced pieces), as follows.

A machine base (1) is fitted with a blade cassette assembly (6), such that the lower pin (5) and the upper pin (4) are on the common axial centerline (2) with all other components of the endoskeletal spindle cartridge above (not shown).

In this embodiment, fruits are located between an upper pin (4) and a lower pin (5), the heads of which have been fitted with subsurface bearings (10 and 11) which allow the fruit (3) to freely spin around the common centerline (2) of the machine, and the theoretical centerline of the core, established by the pins' respective insertion in the stem hole and calyx of the fruit.

A group of one or more circular knives (7) are mounted on a motorized spindle (13) which, along with a carriage housing (14), comprise a carriage assembly which travels on rails (15) when driven by an oil, air, or air-behind-oil cylinder (16), or other linear actuator. The carriage assembly is normally retracted while fruits are hand loaded. After the fruits are loaded, the carriage assembly advances laterally toward the fruit, such that the spinning circular blades (7) pierce the fruit and spin the fruit at the same time. The circular blades are guided by a fixed set of blade spacers which are permanently attached to static support rods (18) emanating from the machine base (1). The blade spacers (17) keep the blades equally spaced on fixed planes which are normal (90°) to the axis of revolution (2), thus assuring that each blade will track in the same path as the fruit is spun through several revolutions.

At the stop position (12), the blades reach the core diameter, but do not cut through it. The carriage then retracts and the fruit is thereafter cored and forced downward through the blade-cartridge by the ram (19).

The locating, coring, ring cutting, “ramming”, retraction and core expulsion are all controlled by an automation system, such that air pressure provided by relays and electric signaling provided by PLCs (programmable logic controllers) effect ring-cutting after and whilst the fruit is located between pins, but before coring and “ramming”; effectively slicing the fruit in two directions in one loading, to create diced pieces.

FIGS. 14A-B illustrate the effect of increasing or decreasing the spacing of blades in a blade cassette, and/or a ring cutting carriage assembly according to exemplary embodiments 2400 and 2401. When an apple is sliced vertically with 12 equally spaced cuts (1), and horizontally with 4 equally spaced cuts (2), the apple is rendered into 48 edible pieces in a matter of seconds. When an apple is sliced vertically with 16 equally spaced cuts (3), and horizontally with 6 equally spaced cuts (4), the apple is rendered into 112 edible pieces in a matter of seconds. In either case, the core is isolated after ring cutting and expelled after “ramming”.

While various aspects of the present disclosure have been illustrated and described, as noted above, many changes can be made without departing from the spirit and scope of the disclosure. Accordingly, the scope of the disclosure is not limited by the disclosure of the above examples.

What is claimed is:

1. A device comprising: twin-opposed coaxial upper and lower guide pins for positioning into a calyx and a stem hole of a fruit having a core, to hold the fruit; a coring tube operable relative to the guide pins for separating the fruit from the core; a cassette including one or more blades for slicing the fruit into slices, the blades as a group arranged in a circle and oriented normal to the circle and having a common center with the lower guide pin; a ram operable relative to the coring tube for force the fruit through the cassette blades; and a proportioning component coaxially positioned relative to the cassette, having a number of channels configured to separate the slices in groups having approximate equal weight.

2. The device of claim 1, further including a stationary endoskeletal structure that encapsulates the upper guide pin, coring tube, and ram.

3. The devices of claims 1 and 2, further being constructed of alternating non-corrosive food-grade materials such that any two materials in sliding contact with each other, have a natural lubricity between them, inherent in their chemistry and/or metallurgy.

4. The device of claim 2, further restraining the moving components of claim 1 in a concentric condition, allowing them to move freely and independently in a telescoping fashion on a common axis, with the lower guide pin and blade-cassette.

5. The device of claim 2, further restrained by one or more platforms which are fixed in space relative to the machine's frame, such that the axis of the endoskeletal structure is in line with the axis of the lower pin and blade-cassette.

6. The device of claim 4, further allowing for the positioning and attachment of respective sets of one or more air cylinders joined to the lintels of the respective moving components of claim 1, such that the cylinders transfer a parallel force and movement through the lintels to said components in their same axial direction without introducing lateral forces or restraints to the components

7. The devices of claims 1 through 6, further being attached to, and controlled by an automation system, such that air pressure provided by relays and electric signaling provided by PLCs provide a coterminous sequence of locating, coring, slicing, and expelling edible fruit pieces and cores or other debris,

8. The devices of claims 1 through 6, further being programmed and controlled by the automation system of claim 7, so as to purposely slice fruits by pushing them partway through the blades but not fully through the blades; and then to locate the next fruit and use it to push the previous fruit fully through the blades, itself being pushed only part way through the blades; thus assuring that no broken ends or separated skins are created by any blade as it exits one fruit and enters the next fruit, cycle after cycle.

9. The devices of claims 1 through 6, further being equally applied to alternate blade slicing patterns and formats; such as sectioning whole fruits without coring; or to non-radial patterns such as slicing rectangular cross sections through the fruit.

10. The devices of claim 1 through 6, further being equally applied to an alternate design of the upper and lower guide pins, such that the heads of both pins are fitted with subsurface bearings, thus allowing the captured fruit to freely rotate or spin.

11. The devices of claims 1 through 10, further including an integrated provision for “horizontal ring cutting”, before coterminous slicing, to effect the slicing of shorter length fruit pieces.

12. The device of claim 11, further designed to cut horizontal bands in the fruit with one or more motor-driven circular blades, to a prescribed distance from the center-axis of a free-spinning captured fruit, so as to undercut the core diameter, but not cut through the core.

13. The device of claim 12, further allowing for singular or multiple circular blades with adjustable spacing, all on a motorized common spindle.

14. The device of claim 13, further designed to slide on rails laterally toward the fruit as a motor-driven unit, concurrently piercing and driving the fruit until a fixed stop point is reached, then retracting to a home position, both motions being controlled by one or more “air behind oil” cylinders.

15. The device of claim 14, further being attached to, and controlled by an automation system, such that air pressure provided by relays and electric signaling provided by PLCs effect ring-cutting after and whilst the fruit is located between pins, but before coring and “ramming”; effectively slicing the fruit in two directions in one loading, to create diced pieces.

16. A method for proportioning slices of fruit, the method comprising:
slicing a piece of fruit into a number of slices using an endoskeletal or other slicing and coring device;
and separating the slices into a number of groups using a proportioning device, wherein each of the groups comprises slices taken at fixed intervals around the center of the sliced fruit, and wherein based on the fixed intervals of selected slices, each group meets an equal minimum weight requirement.

17. A device based on the method of claim 16, designed to locate directly under a blade cassette as described in claim 1, with a radial pattern of shoots, identical in size and shape to the gaps between blades in the aforementioned cassette, and positioned such that webs between shoots line up exactly with blades, such that all fruit wedges will fall into their respective proportioner shoots.

18. The device of claim 17, further designed to channel fruit wedges, into groups of wedges at alternating fixed intervals, equally spaced around the blade cassette, such that each group comprises wedges that are radially symmetric with each other, and therefore collectively equal in weight to every other group of collected wedges.

19. The device of claim 18, further designed to channel groups of wedges into separate exit zones which, each in turn, feed down-stream processing and/or packaging means, such that all groups of wedges maintain their collective equal weights through the process.

20. The device of claim 19, further designed such that all surfaces in contact with fruit wedges are coated or otherwise manufactured, to prevent surface-friction an/or adhesion with the wedges during the channeling of the fruit wedges.
